(19) United States
(12) Patent Application Publication
(10) Pub. No.: US 2015/0227944 A1
(43) Pub. Date: Aug. 13, 2015

(54) SYSTEMS AND METHODS FOR PROVIDING HEALTHCARE SERVICES

(71) Applicant: Inmate Health Services LLC, Saint Davids, PA (US)

(72) Inventor: David D. Comey, Saint Davids, PA (US)

(21) Appl. No.: 14/619,197

(22) Filed: Feb. 11, 2015

Related U.S. Application Data
(60) Provisional application No. 61/938,946, filed on Feb. 12, 2014.

(51) Int. Cl. G06Q 30/00; G06Q 50/22; G06Q 50/26; G06F 19/00

(52) U.S. Cl. CPC G06Q 30/018; G06F 19/322; G06Q 50/22; G06Q 50/26

(57) ABSTRACT

A system includes a non-transitory machine readable storage medium and a processor in communication with the non-transitory machine readable storage medium. The processor is configured to analyze a database of patient healthcare data to identify a violation of a protocol for providing a patient with one or more medical procedures, determine an estimated cost for providing the patient with the one of more medical procedures if the protocol were to be followed, calculate a difference between a cost for providing the one or more medical procedures in violation of the protocol and the estimated cost for providing the inmate with the one or more medical procedures in accordance with the protocol, and generate an electronic notice identifying the violation of the protocol and at least one of a corrective action to be taken and a savings value if the corrective action is taken.

### CROSS-REFERENCE TO RELATED APPLICATIONS

This application claims priority to U.S. Provisional Patent Application No. 61/938,946, filed Feb. 12, 2014, the entirety of which is incorporated by reference herein.

### FIELD OF DISCLOSURE

The disclosed systems and methods relate to healthcare. More particularly, the disclosed systems and methods relate to providing healthcare services to inmates.

### BACKGROUND

Various online appointment reservation systems are available commercially. Primarily, these online reservation systems typically provide users with the ability to make reservations for car rentals, restaurants, and other activities. One unique reservation system is provided by Inmate Health Services, LLC (“IHS”), which provides registered users, such as IHS employees, prison or correctional facility employees, and onsite medical professionals, with the ability to schedule appointments for providing inmates with various health services. The IHS platform additionally provides users with recommendations as to where a particular medical procedure should be performed to reduce medical costs for providing the medical treatment.

### SUMMARY

In some embodiments, a system includes a non-transitory machine readable storage medium and a processor in communication with the non-transitory machine readable storage medium. The processor is configured to analyze a database of patient healthcare data to identify a violation of a protocol for providing a patient with one or more medical procedures, determine an estimated cost for providing the patient with the one of more medical procedures if the protocol were to be followed, calculate a difference between a cost for providing the one or more medical procedures in violation of the protocol and the estimated cost for providing the inmate with the one or more medical procedures in accordance with the protocol, and generate an electronic notice identifying the violation of the protocol and at least one of a corrective action to be taken and a savings value if the corrective action is taken.

In some embodiments, a method includes analyzing a database of healthcare data to identify a violation of a protocol for providing a patient with one or more medical procedures, determining an estimated cost for providing the patient with the one of more medical procedures if the healthcare protocol were to be followed, and calculating a difference between a cost for providing the one or more medical procedures in violation of the protocol and the estimated cost for providing the inmate with the one or more medical procedures in accordance with the protocol. An electronic notice identifying the violation of the protocol and at least one of a corrective action to be taken and a savings value if the corrective action is taken is generated.

### BRIEF DESCRIPTION OF THE DRAWINGS

FIG. lA illustrates one example of a system including an inmate health scheduling network in accordance with some embodiments.

FIG. 1B illustrates one example of an architecture of a mobile device in accordance with some embodiments.

FIG. 2 is a flow chart of one example of a method of scheduling an appointment in accordance with some embodiments.

FIG. 3A illustrates one example of a GUI presented to a user to gain access to a system in accordance with some embodiments.

FIG. 3B illustrates one example of a GUI presented to a user after the user gains access to the system and providing the user with one or more options for taking action in accordance with some embodiments.

FIG. 3C illustrates one example of a GUI presented to a user for performing a search in accordance with some embodiments.

FIG. 3D illustrates one example of a GUI presented to a user showing the results of a search performed based on data entered into the GUI illustrated in FIG. 3C in accordance with some embodiments.

FIG. 3E illustrates one example of a GUI presented to a user for requesting an appointment in accordance with some embodiments.

FIG. 3F illustrates one example of a GUI presented to a user once an appointment request has been submitted in accordance with some embodiments.

FIG. 3G illustrates one example of a GUI presented to a user for providing access to upload one or more files to a system in accordance with some embodiments.

FIG. 3H illustrates one example of a GUI presented to a user for searching for an existing appointment in accordance with some embodiments.

FIG. 3I illustrates one example of a GUI presented to a user showing the results of a search performed by a system based on information entered into the GUI shown in FIG. 3H in accordance with some embodiments.

FIG. 3J illustrates one example of a GUI displaying information concerning a requested appointment in accordance with some embodiments.

FIG. 3K illustrates one example of a GUI presented to a user for cancelling and/or rescheduling an appointment in accordance with some embodiments.

FIG. 3L illustrates one example of a GUI displayed to a user for logging an emergency room (“ER”) visit in accordance with some embodiments.

FIG. 3M illustrates one example of a GUI providing a user with an ability to select one or more report types for a system to generate in accordance with some embodiments.

FIG. 3N illustrates one example of a GUI for entering in criteria for generating a report in accordance with some embodiments.

FIG. 4 illustrates one example of an offsite provider form accordance with some embodiments.

FIG. 5 illustrates one example of an appointment reminder report in accordance with some embodiments.

FIG. 6 illustrates one example of an ER visit tracking report in accordance with some embodiments.

FIG. 7 is a flow diagram of one example of a method of identifying a violation and generating an alert or report in accordance with some embodiments.

### DETAILED DESCRIPTION

This description of the exemplary embodiments is intended to be read in connection with the accompanying drawings, which are to be considered part of the entire written description.

Prison healthcare systems are a significant financial burden at all levels, e.g., federal, state and local. The IHS platform described above helps facilitate cost-effective treatment through its recommendations but that platform provides medical procedure location recommendations to the user only at the time at which a user submits a request for an appointment. As such, the platform does not ensure that such cost-effective recommendations are followed nor does the system suggest cost-effective alternatives once treatment has begun. There remains a need for a reservation system, particularly for use in an incarceration health system, that analyzes healthcare data, including appointment reservations and on-going patient treatment information, to identify potential cost savings in an inmate's treatment, for example by changing a location of a future appointment and/or moving a patient from one treatment center to another. Moreover, improvements in such automated inmate health reservation systems are realized by proactively alerting users of such potential savings in advance of follow through with scheduled or on-going costly treatments.

The disclosed systems and methods advantageously a healthcare appointment and management system that analyzes healthcare data and identifies when a recommendation of the system has not been followed (i.e., a protocol violation) and an increase in cost is being incurred because the recommendation is not being following. Additionally, the disclosed systems and methods advantageously notify one or more users of the violation, a proposed resolution to the violation, and an estimated potential savings that would be realized if the proposed resolution is followed.

Further, the disclosed systems and methods enable an inbound call center and staff of a health provider system to receive and enter requests for medical care for prison inmates, find optimal providers, store appointment and claim information, and provide analysis and reporting for stakeholders including, but not limited to, physicians, hospitals, insurance companies, and third-party administrators (“TPAs”) of healthcare providers. The advantages afforded by the disclosed systems and methods also include the ability to improve clinical outcomes by avoiding adverse events, reduced cost of care by limiting the reliance on highly restricted networks of hospitals and specialty physicians, and improved access to data and reports to provide more effective analysis of services, utilization, and quality of financial metrics and customized reporting. The disclosed systems and methods also provide improved transparency of costs and expenses in a more timely fashion.

As described in greater detail below, the disclosed systems, devices, and methods are implemented over networks such as, for example, the Internet. The Internet is a worldwide system of computer networks—a network of networks in which a user at one computer, terminal, or other device connected to the network can obtain information from any other computer, terminal, or device and communicate with users of other computers or devices. The most widely used part of the Internet is the World Wide Web (often-abbreviated “WWW” or called “the Web”).

One of the features of the Web is its use of hypertext, which is a method of cross-referencing. In most Web sites, certain words or phrases appear in text of a different color than the surrounding text. This text is often also underlined. Sometimes, there are hot spots, such as buttons, images, or portions of images that are “clickable.” Clicking on hypertext or a hot spot causes the downloading of another web page via a protocol such as hypertext transport protocol (HTTP). Using the Web provides access to millions of pages of information. Web “surfing” is done with a Web browser such as, for example, Apple Safari, Microsoft Internet Explorer, Mozilla Firefox, and Google Chrome. The appearance of a particular website may vary slightly depending on the particular browser used. Versions of browsers have “plug-ins,” which provide animation, virtual reality, sound, and music. Interpreted programs (e.g., applets) may be run within the browser.

System Overview

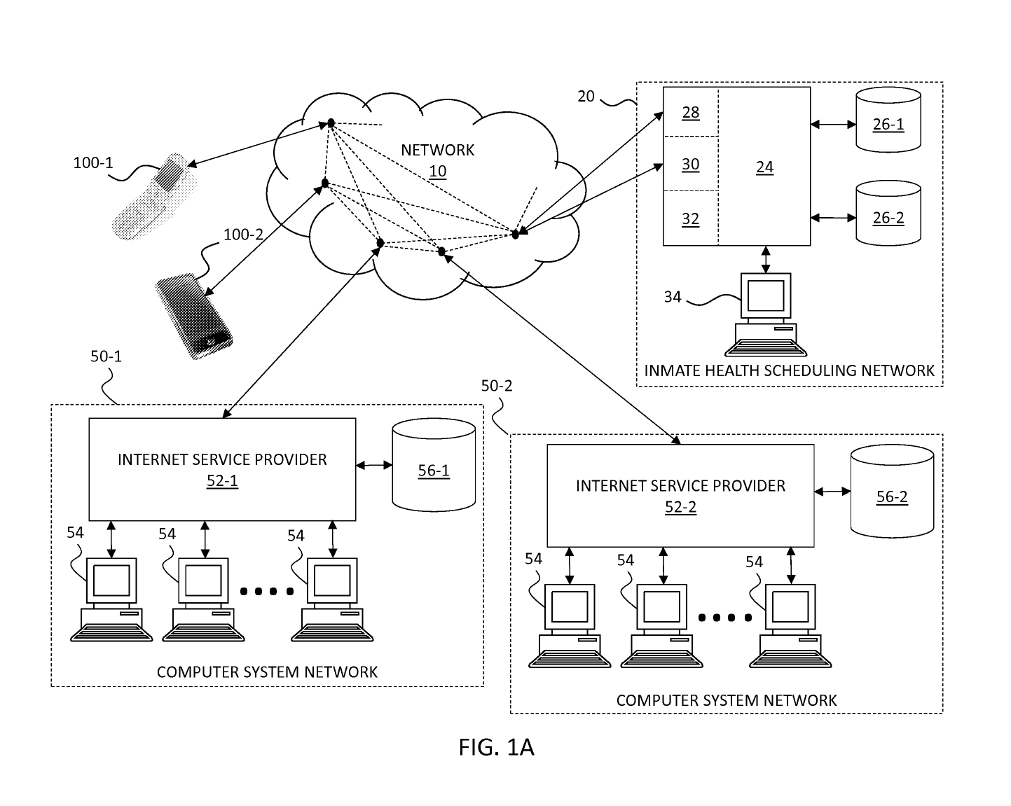

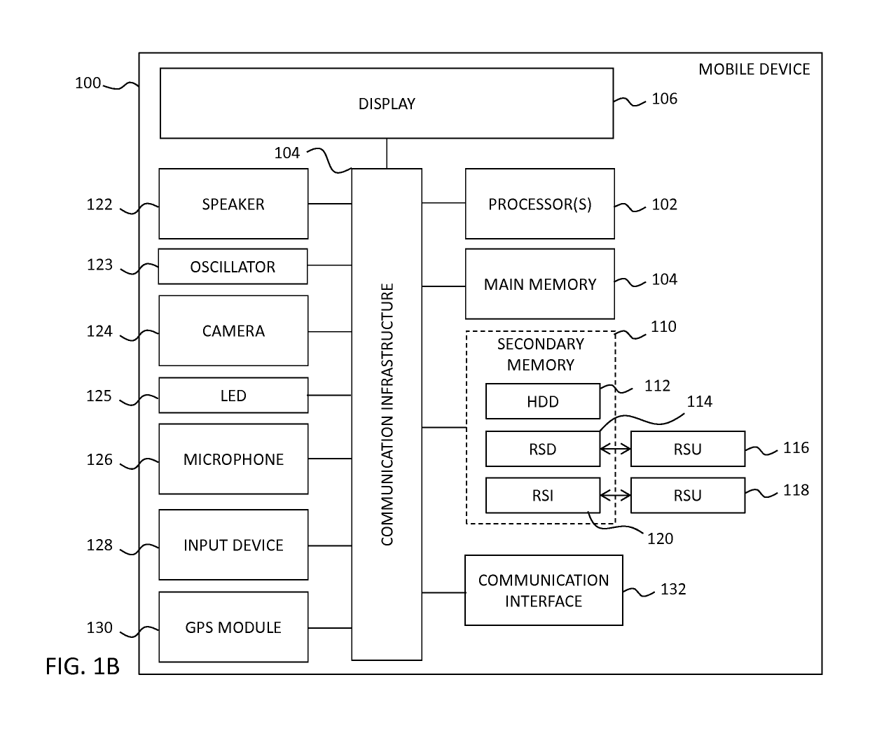

FIG. 1A depicts one example of a system in which a plurality of wireless devices 100-1 and 100-2 (collectively “wireless devices 100” or “mobile devices 100”) are connected via network 10 to one or more computer system networks 50-1, 50-2 (“computer networks 50”), to Inmate Health Scheduling Network (“IHSN”) 20, and to call center network 60. Network 10 may be a wide area network (“WAN”), a local area network (“LAN”), personal area network (“PAN”), or the like. In one embodiment, network 10 is the Internet and mobile devices 100 are online. “Online” may mean connecting to or accessing source data or information from a location remote from other devices or networks coupled to network 10.

IHSN 20 includes a processing unit 24 coupled to one or more data storage units 26-1, 26-2 (collectively referred to as “data storage units 26”). The processing unit 24, in some embodiments, is configured to provide front-end graphical user interfaces (“GUIs”), e.g., a prison user GUI 28, a call center GUI 30, and a back-end or administrative GUI or portal 32 to one or more remote computers 54 or to one or more local computers 34. In some embodiments, a physician interface (not shown) is provided and/or a physical accesses IHSN 20 via GUI 28. The GUIs can take the form of, for example, a webpage that is displayed using a browser program local to remote computers 54 or to one or more local computers 34. It is understood that the IHSN 20 may be implemented on one or more computers, servers, or other computing devices. For example, IHSN 20 may include servers programmed or partitioned based on permitted access to data stored in data storage units 26. Front-and back-end GUIs 28, 30, 32 may be portal pages that include various content retrieved from the one or more data storage devices 26. As used herein, “portal” is not limited to general-purpose Internet portals, such as YAHOO! or GOOGLE but also includes GUIs that are of interest to specific, limited audiences and that provide the party access to a plurality of different kinds of related or unrelated information, links and tools as described below. “Webpage” and “website” may be used interchangeably herein.

Remote computers 54 may be part of a computer system network 50-1, 50-2 and gain access to network 10 through an Internet service provider (“ISP”) 52-1, 52-2 (“ISPs 52”). Mobile devices 100 may gain access to network 10 through a wireless cellular communication network, a WAN hotspot, or through a wired or wireless connection with a computer as will be understood by one skilled in the art. Prison and call center personnel (and other users, such as medical personnel in some embodiments) may use remote computers 54 and/or mobile devices 100 to gain access to IHSN 20.

In one embodiment, mobile devices 100 includes any mobile device capable of transmitting and receiving wireless signals. Examples of mobile instruments include, but are not limited to, mobile or cellular phones, personal digital assistants (“PDAs”), laptop computers, tablet computers, music players, and e-readers, to name a few possible devices.

FIG. 1B is a block diagram of one example of an architecture of mobile device 100. As shown in FIG. 1B, mobile device 100 includes one or more processors, such as processor(s) 102. Processor(s) 102 may be any central processing unit (“CPU”), microprocessor, micro-controller, or computational device or circuit for executing instructions. Processor(s) are connected to a communication infrastructure 104 (e.g., a communications bus, cross-over bar, or network). Various software embodiments are described in terms of this exemplary mobile device 100. After reading this description, it will be apparent to one of ordinary skill in the art how to implement the method using mobile devices 100 that include other systems or architectures. One of ordinary skill in the art will understand that computers 34, 54 may have a similar and/or identical architecture as that of mobile devices 100. Put another way, computers 34, 54 can include some, all, or additional functional components as those of the mobile device 100 illustrated in FIG. 1B.

Mobile device 100 includes a display 106 that displays graphics, video, text, and other data received from the communication infrastructure 104 (or from a frame buffer not shown) to a user (e.g., a subscriber, commercial user, back-end user, or other user). Examples of such displays 106 include, but are not limited to, LCD screens, OLED display, capacitive touch screen, and a plasma display, to list only a few possible displays. Mobile instrument 100 also includes a main memory 108, such as a random access (“RAM”) memory, and may also include a secondary memory 110. Secondary memory 110 may include a more persistent memory such as, for example, a hard disk drive (“HDD”) 112 and/or removable storage drive (“RSD”) 114, representing a magnetic tape drive, an optical disk drive, solid state drive (“SSD”), or the like. In some embodiments, removable storage drive 114 reads from and/or writes to a removable storage unit (“RSU”) 116 in a manner that is understood by one of ordinary skill in the art. Removable storage unit 116 represents a magnetic tape, optical disk, or the like, which may be read by and written to by removable storage drive 114. As will be understood by one of ordinary skill in the art, the removable storage unit 116 may include a tangible and non-transient machine readable storage medium having stored therein computer software and/or data.

In some embodiments, secondary memory 110 may include other devices for allowing computer programs or other instructions to be loaded into mobile device 100. Such devices may include, for example, a removable storage unit (“RSU”) 118 and a corresponding interface (“RSI”) 120. Examples of such units 118 and interfaces 120 may include a removable memory chip (such as an erasable programmable read only memory (“EPROM”)), programmable read only memory (“PROM”)), secure digital (“SD”) card and associated socket, and other removable storage units 118 and interfaces 120, which allow software and data to be transferred from the removable storage unit 118 to mobile device 100.

Mobile device 100 may also include a speaker 122, an oscillator 123, a camera 124, a light emitting diode (“LED”) 125, a microphone 126, an input device 128, and a global positioning system (“GPS”) module 130. Examples of input device 128 include, but are not limited to, a keyboard, buttons, a trackball, or any other interface or device through a user may input data. In some embodiment, input device 128 and display 106 are integrated into the same device. For example, display 106 and input device 128 may be touchscreen through which a user uses a finger, pen, and/or stylus to input data into mobile instrument 100.

Mobile device 100 also includes one or more communication interfaces 132, which allows software and data to be transferred between mobile device 100 and external devices such as, for example, another mobile device 100, a computer 34, 54 and other devices that may be locally or remotely connected to mobile device 100. Examples of the one or more communication interfaces 132 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. The one or more communication interfaces 132 may also include a wireless interface configured for short range communication, such as near field communication (“NFC”), Bluetooth, or other interface for communication via another wireless communication protocol. As briefly noted above, one of ordinary skill in the art will understand that computers 34, 54 and portions of IHSN 20 may include some or all components of mobile device 100.

Software and data transferred via the one or more communications interfaces 132 are in the form of signals, which may be electronic, electromagnetic, optical, or other signals capable of being received by communications interfaces 132. These signals are provided to communications interface 132 via a communications path or channel. The channel may be implemented using wire or cable, fiber optics, a telephone line, a cellular link, a radio frequency (“RF”) link, or other communication channels.

In this document, the terms “non-transitory computer program medium” and “non-transitory computer readable medium” refer to media such as removable storage units 116, 118, or a hard disk installed in hard disk drive 112. These computer program products provide software to mobile device 100. Computer programs (also referred to as “computer control logic”) may be stored in main memory 108 and/or secondary memory 110. Computer programs may also be received via the one or more communications interfaces 132. Such computer programs, when executed by a processor(s) 102, enable the mobile device 100 to perform the features of the method discussed herein.

In an embodiment where the method is partially or entirely implemented using software, the software may be stored in a computer program product and loaded into mobile device 100 using removable storage drive 114, hard drive 112, and/or communications interface 132. The software, when executed by processor(s) 102, causes the processor(s) 102 to perform the functions of the method described herein. In another embodiment, the method is implemented primarily in hardware using, for example, hardware components such as application specific integrated circuits (“ASICs”). Implementation of the hardware state machine so as to perform the functions described herein will be understood by persons skilled in the art. In yet another embodiment, the method is implemented using a combination of both hardware and software.

Referring again to FIG. 1A, IHSN 20 is accessible by call center personnel via local or remote computers 34, 54 and by prison personnel via remote computers 54. In some embodiments, these users gain access to the content using a mobile device 100. As briefly noted above, in some embodiments IHS personnel (e.g., call center personnel) gain access to IHSN 20 via portal 30, which enables call center personnel to schedule appointments, generate reports, and perform other functions as described in greater detail below. In some embodiments, prison personnel gain access to IHSN 20 via portal 28 and are provided with the ability to review and schedule appointments, review reports, and perform other functions described in greater detail below.

IHSN 20 is scalable. For example, in some embodiments, IHSN 20 is configured to receive or otherwise process 12,000-14,000 tickets per year (40 per day). However, in some embodiments, IHSN 20 can be scaled to service a volume of 10× or more (e.g., 400+ requests) per day to provide one non-limiting example. IHSN 20 also is configured to integrated with other systems that may be run by the company providing IHSN 20 or using IHSN 20, such as a call center, and one or more third-party administrators (“TPAs”), to list only a few examples. In some embodiments, IHSN 20 has redundancy (two paths) and no single point of failure.

In some embodiments, IHSN 20 System is secured (i.e. encrypted data on servers, etc.) and all connectivity (real time and batch file) transmissions must be encrypted.

IHSN 20 is configured to enable onsite professionals to enter medical history for each inmate and to store this information in one or more data storage units 26. As described in greater detail below, IHSN 20 is configured to fax, email, or otherwise transmit appointment information to the selected provider, recall from a data storage unit 26 information to be updated as appropriate when an onsite medical professional, call center professional, or other user, makes another appointment for an inmate, and store the most recently entered security requirements for each inmate in the system. In some embodiments, each time a new appointment is made for an inmate, the latest security requirements are retrieved and displayed to the user to save entry time, and enable the onsite medical professional to update as appropriate.

Database Management

IHSN 20 is configured to accept file(s) from various sources such as, for example, prisons, TPAs, such as Cigna Corporation, BlueCross BlueShield Association, Amerihealth, or other healthcare management entity, insurance companies, hospital, physicians, and through manual input as disclosed in greater detail below. Advantageously, IHSN 20 is configured to receive data in a variety of different forms and formats, and merge the data into a single database, which is stored in one or more data storage units 26, enabling a variety of reports to be computed using processor(s) 24. In some embodiments, IHSN 20, and more particularly processor(s)24 of IHSN 20, executes a secure correctional appointment network (“SCAN”) algorithm based on the data stored in the one or more data storage units 26. The SCAN algorithm takes into account medical cost related factors, quality related factors, distance related factors, risk mitigation related factors, and time constraint factors to identify efficient (in cost and time) healthcare providers to treat inmates.

The database stored in the one or more data storage units 26 can be populated in a variety of ways. For example, IHSN 20 is configured to receive a list of inmates eligible for healthcare treatment. In some embodiments, the list of inmates is updated daily; however one of ordinary skill in the art will understand that the list of inmates may be updated more frequently or less frequently. IHSN 20 is configured to verify that inmate treatment requests are only for inmates on this list. If they are not on the list, a user is provided with the ability to create a new record for the inmate, as described in greater detail below, so that an appointment can be made for the inmate. If strict eligibility validation is being enforced for a client, and a request is made for someone not on the list, IHS can be contacted to work with client and a third-party administrator (“TPA”) to resolve the issue.

In some embodiments, the following feed files are periodically received or uploaded through back end portal 32 of IHSN 20: appointments data, including new appointments that have reached a status of “scheduled and confirmed”, as well as updates to these appointments (cancellations, completions), inmate census feed (full file refresh of all inmates each day), to list only a few possibilities. These periodic updates can occur hourly, daily, weekly, etc. IHSN 20 is configured to a confirmation response file to validate that the file was received and processed correctly. In some embodiments, a full refresh of appointments data is uploaded to IHSN 20 via back-end portal 32 to resynchronize the system. In some embodiments IHSN 20 provides a call center from the back end of IHSN 20 for the following sets of data: census update including a TPA's inmate ID numbers.

Upon receiving the data from the disparate sources, including the manual entry of information described in greater detail below, processor(s) 24 parse the received files and extract the underlying data. In some embodiments, the data is associated with a unique identifier that is calculated for a particular patient, appointment request, and medical record. A new database is constructed and stored in the one or more data storage units 26. This new database is optimized for running algorithms to obtain financial and other metrics concerning healthcare related costs for inmates. In addition to be used to create a new database, the information received and stored in data storage units 26 can be backed up for security and for use in analysis and reporting—functions that are described in greater detail below.

Request/Appointment Scheduling

IHSN 20 is configured to enable users to request and create an appointment for an inmate to meet a particular requirement (e.g., date, time, provider, location), confirm the appointment, and/or cancel the appointment. In some embodiments, IHSN 20 maintains a list of email address(es) for each facility (e.g., prison) in a database stored in storage medium 26. As described in greater detail below, a confirmation is sent from the call center employee to the prison facility via email.

As described in greater detail below, IHSN 20 is configured to provide a list of optimized provider (e.g., medical provider) choices to a call center operator or other user. IHSN 20 shows the appropriate provider list (e.g., a list provided from a TPA for processing a claim) for the inmate based on the facility and jurisdiction for that inmate. IHSN 20 also enables call center personnel or other users to enter appointment information into IHSN 20. If a request is made via phone, fax or email, the call center operator or user of the IHSN 20 is able to enter initial data into appointments scheduling system, by keying into a form displayed by IHSN 20 as shown and described below.

In some embodiments, a call center operator will then schedule an appointment. For example, a call center operator can choose a provider from a TPA's optimized provider list (optimized based on distance, cost, compliance with security protocols, etc.). If no provider is available in the geographic area, time frame, etc., the call center operator will call a TPA's Account Executive (or the backup) and s/he will find another appropriate provider and call the operator back. Note that, in some embodiments, a call center operator will not assume that this new provider will be added to the provider list. A TPA will maintain the provider lists and will add this provider if they agree to see inmates going forward. In some embodiments, IHSN 20 system is configured to allow for this provider to be entered for this appointment even though it's not in the official approved list of providers.

If a facility/jurisdiction combination includes a non-TPA in network providers, IHSN 20 is configured to show call center staff the current list of providers (as supplied by the client) followed by the list of TPAs in network providers (as backup).

In some embodiments, a list of providers, hours available (if available), gender(s) allowed, security level allowed, etc. (as provided by a TPA) to be provided by a TPA and client (as appropriate) is provided to IHSN 20. The list is prioritized such that each facility has an ordered list of providers by specialty, rank and rank group. Rank group will indicate to call center operators how much more expensive each non-optimal provider is compared to top ranked provider. If provider is not in the top few rank groups, a call center operator will try to work with facility to adjust requirements for appointment to use more optimal provider, if possible. In some embodiments, IHSN 20 is configured to show a user a list of currently scheduled appointments (including security level, gender, etc.) for the providers when this list is shown to enable operator to coordinate optimal scheduling (i.e. batching).

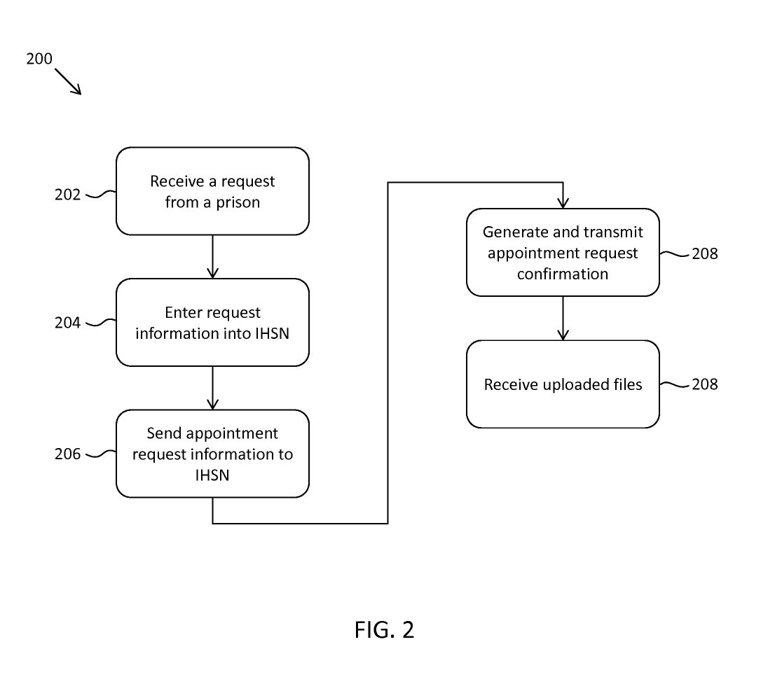

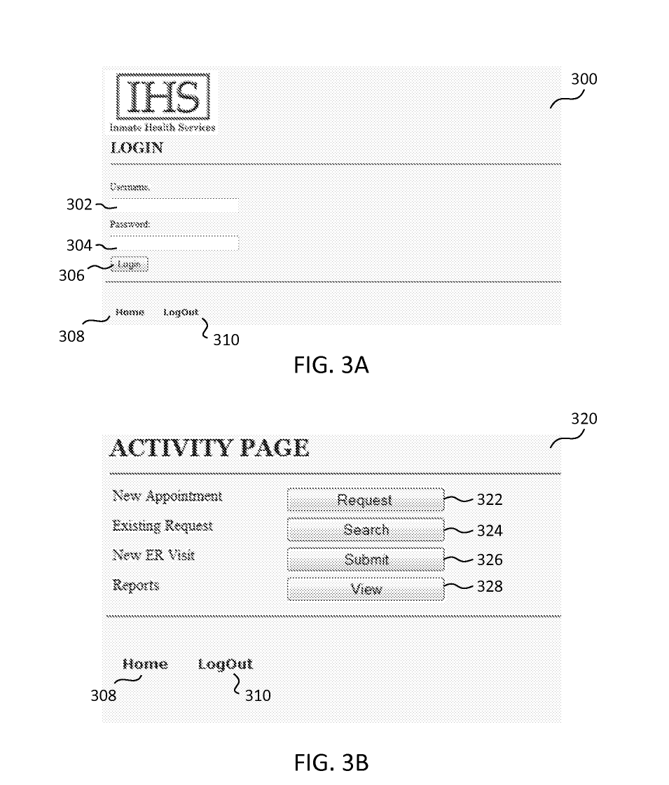

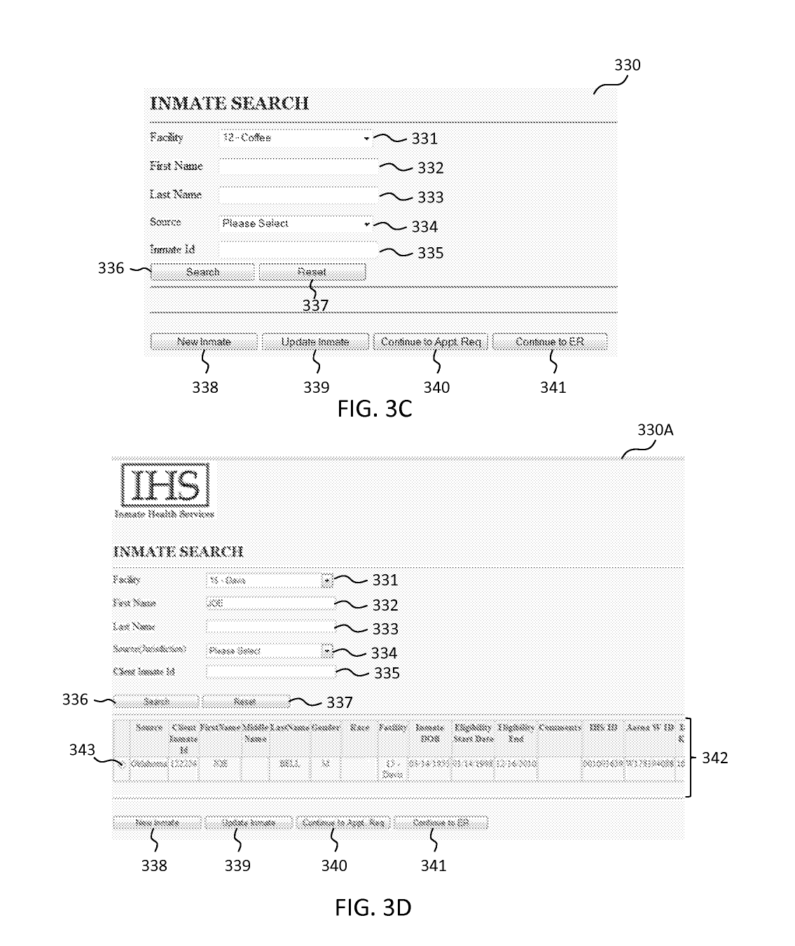

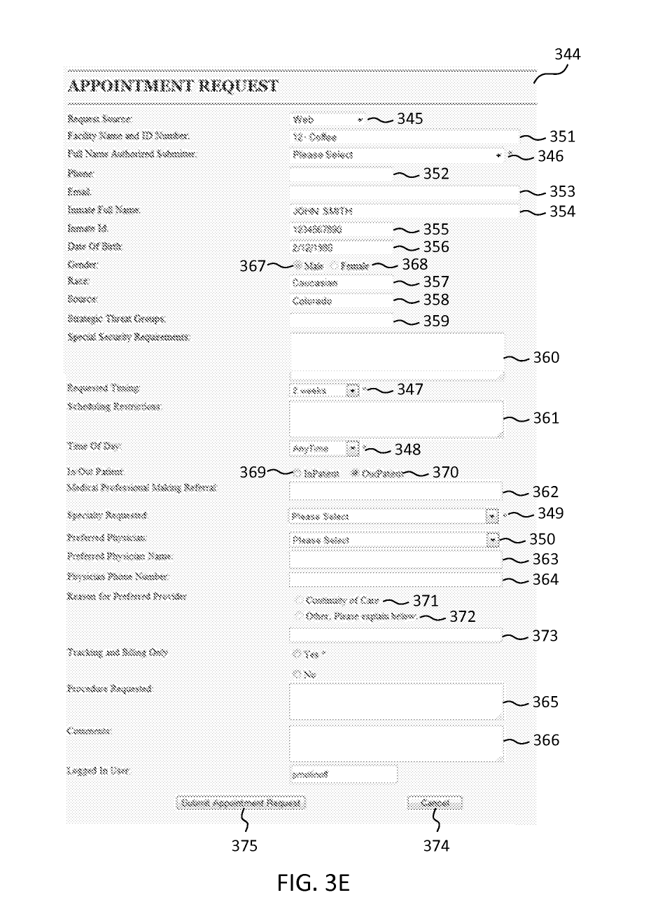

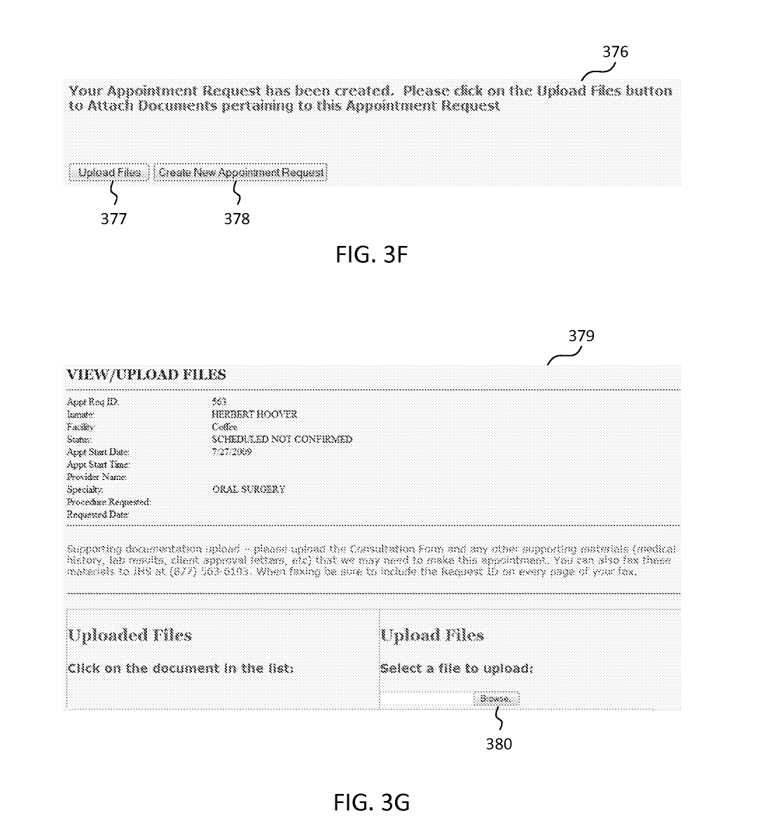

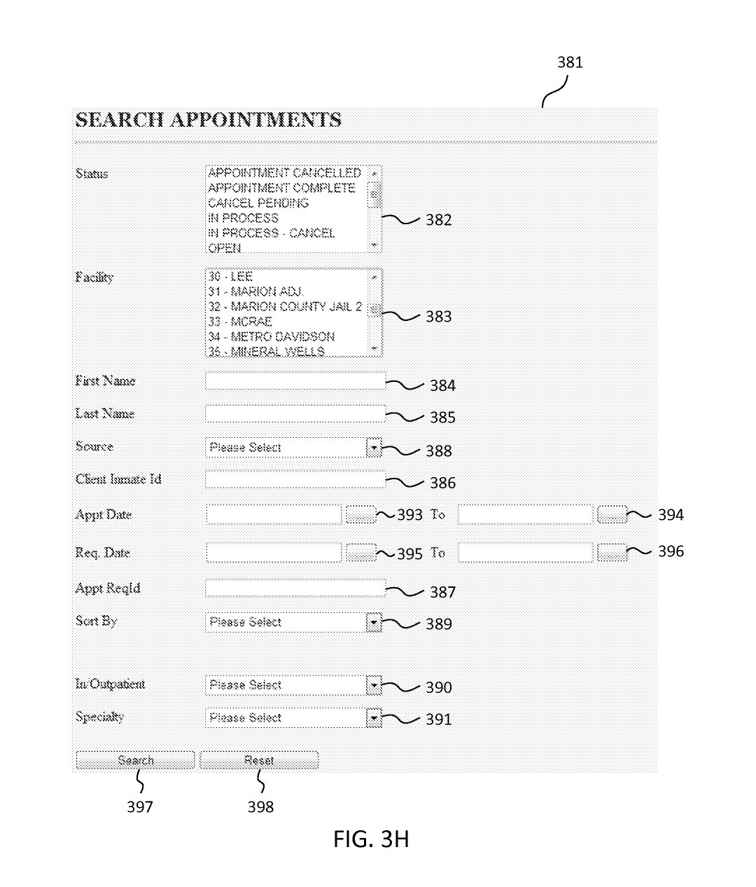

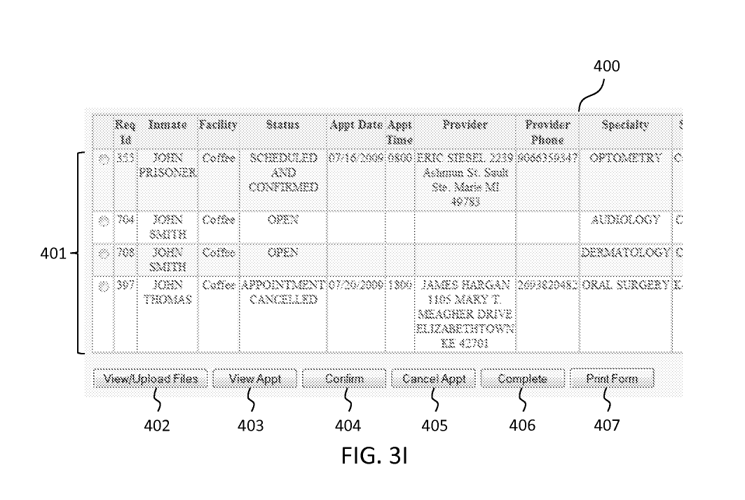

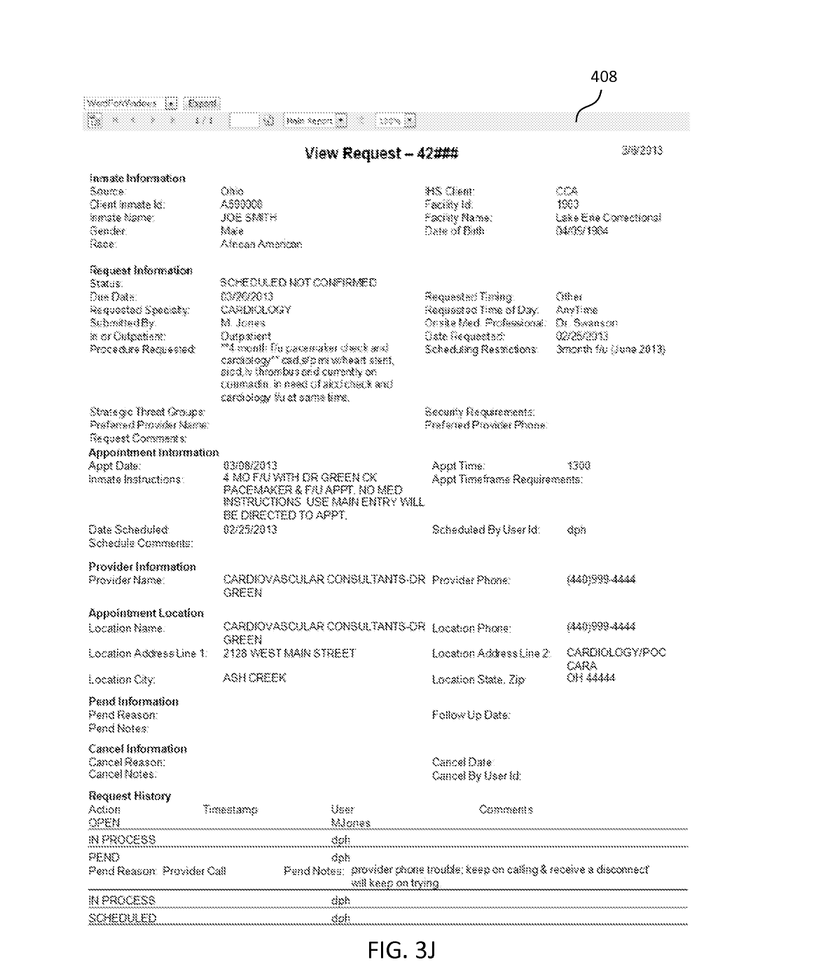

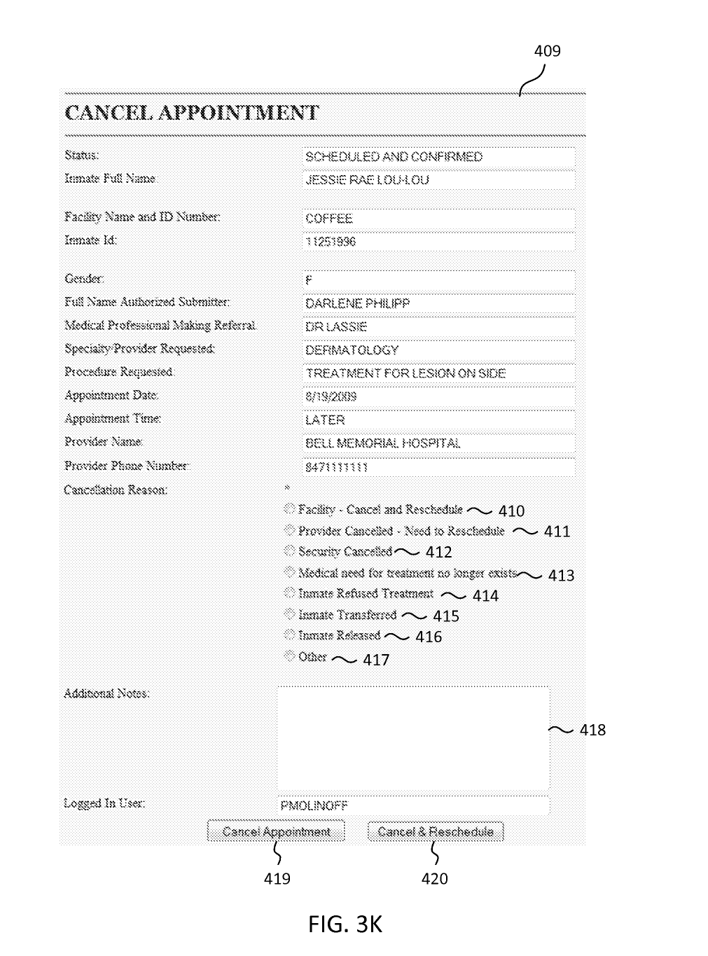

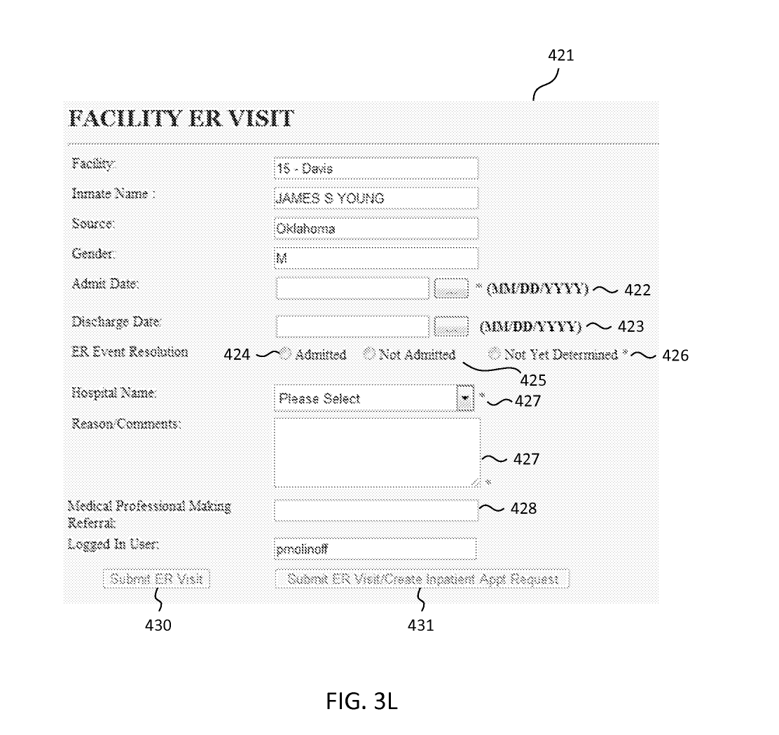

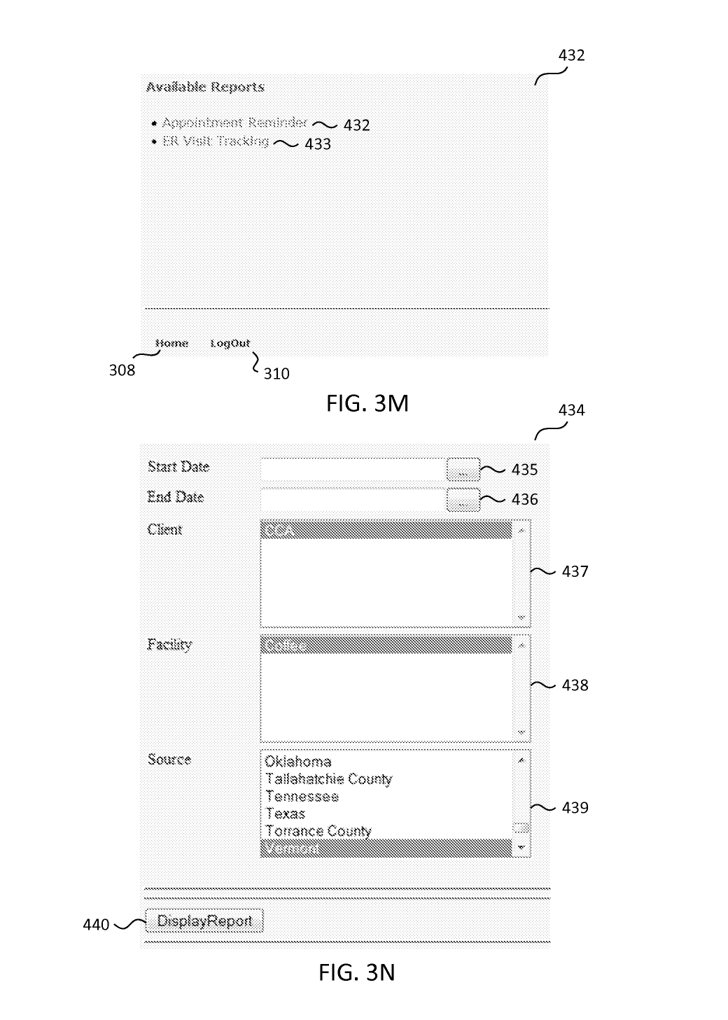

The scheduling functionality provided by IHSN 20 is described with reference to FIGS. 2-3G in which FIG. 2 is a flow chart of one example of a method 200 of scheduling an appointment in accordance with some embodiments.

At block 202, a call center (e.g., IHS) employee or operator receives a communication (e.g., an email, fax, or phone call) from a prison in the form of an appointment request. In some embodiments, the request includes an onsite medical professional's initial medical treatment request details or an onsite medical professional will enter medical request using a mobile device 100 or computer 54 via portal 28 of IHSN 20. IHSN 20 includes appropriate security provisions to prevent unauthorized entry. For example, an employee is presented with a login GUI, which may take the form of GUI 300 illustrated in FIG. 3. GUI 300 includes a text entry field 302 for entering a username and another text entry field 304 for entering a password. A “Login” button 308 is provided for sending the information entered in fields 302, 304 for processing by processor 24 and determining whether the entered username and password match information stored in an existing user profile stored in a data storage unit 26. GUI 300 also includes a “Home” button 308 and a “LogOut” button 310. Clicking the Home button 308 will return the user to a home GUI, and clicking the LogOut button 310 will log the user out of the IHSN 20. In some embodiments, IHSN 20 may prompt a user to enter a periodically expiring password and/or be configured to have screens (GUIs) that time out after a certain period of time (e.g., seconds, minutes, etc.).

At block 202, the user enters the information included in the request into IHSN 20. For example, once the user has logged into IHSN 20 using GUI 300, the user is taken to an “Activity Page” GUI 320 shown in FIG. 3B. GUI 320 includes buttons 308 and 310, described above, and a new appointment “Request” button 322, an appointment “Search” button 324, a new emergency room (“ER”) visit “Submit” button 326, and a report “View” button 328. To create a new appointment the user clicks Request button 322.

IHSN 20 provides the user with another GUI, which in some embodiments is in the form of the “Inmate Search” GUI 330 illustrated in FIG. 3C. As shown in FIG. 3C, GUI 330 includes a facility drop-down menu 331 in which the user can select the facility housing the inmate/patient. GUI 330 also includes text entry fields 332, 333 for entering the first and last names of the patient for which the appointment request is being made. A source pull-down menu 334 includes a number of registered jurisdictions, such as state or city, and an inmate ID text entry field 335 in which a user can enter the identification number of the inmate.

GUI 330 also includes a number of buttons, including a “Search” button 336 for searching for the inmate based on the information provided in the pull-down menus and text entry fields, and a “Reset” button 337 also is provided for clearing all information entered in the pull-down menus and text entry fields. A “New Inmate” button 338 is provided to take the user to an inmate entry page, and an “Update Inmate” button 339 is provided to take the user to a page where the personal data of an inmate can be updated or edited. The button “Continue to Appt. Req.” button 340 will take the user to another page for continuing with the appointment request, and a “Continue to ER” button 342 will take the user to make an appointment for an ER visit.

FIG. 3D illustrates one example of a GUI 330A, which is a modified version of GUI 330 and is presented to a user when the user clicks on Search button 336 in GUI 330 illustrated in FIG. 3C. As shown in FIG. 3D, GUI 342 displays one or more inmates in area 342 matching the search criteria entered into IHSN 20 using the pull-down menus and/or text entry fields provided in GUI 330. A selection button 343 is provided for each inmate matching the entered search criteria. If one of the one or more inmates shown in area 342 is the inmate for which the appointment request is to be made, a user clicks the button 343 next to the inmates name and clicks button 340.

FIG. 3E illustrates one example of an “Appointment Request” GUI 344 in accordance with some embodiments. GUI 344 includes numerous pull-down menus and text entry fields providing the user with the ability to enter information obtained from the incoming request. One of ordinary skill in the art will understand that fewer or more pull-down menus and text entry fields can be provided in an appointment request GUI, and the manner in which data is input into the GUI, e.g., by pull-down menu, radio button, text entry field, can also be modified. In some embodiments, the pull-down menus provided by GUI 344 include, but are not limited to, a Request Source menu 345, which enables a user to select the origin of the request, e.g., the Internet/web, email, telephone, etc.; an Authorized Submitter menu 346, which lists the employees or personnel authorized to submit such requests; a Required Timing menu 347, which identifies the urgency of the requested appointment in a matter of hours, days, weeks, etc.; a Time of Day menu 348; a Specialty Requested menu 349, which identifies if a particular type of doctor or specialized physician is needed for the appointment; and a Preferred Physician menu 350.

Examples of the text entry fields provided by GUI 344 include, but are not limited to, a Facility Name Authorized Submitter field 351, a Phone number field 352, an Email field 353, an Inmate Full Name field 354, an Inmate ID field 355, a Date of Birth field 356, a Race field 357, a Source (e.g., jurisdiction) field 358, a Strategic Threat Group field 359, a Special Security Requirement field 360, a Scheduling Restriction field 361, a Medical Professional Making Referral field 362, a Preferred Physician Name field 363, a Physician Phone Number field 364, a Procedure Requested field 365, and a Comments field 366. In some embodiments, GUI 344 also includes selection buttons for gender (e.g., a male button 367 and female button 368), patient type (e.g., InPatient 369 and OutPatient 370), and Reason for Preferred Provider (e.g., Continuity of Care 371 or Other 372). If the Other button is selected, a text entry box 373 is provided for a user to provide a reason for the preferred provider. A Yes button 374 and a No button 375 also are provided for identifying whether the appointment has already been scheduled or completed.

A Cancel button 374 also is provided by GUI 344. If the Cancel button 374 is clicked, then the user is taken away from GUI 344. Once the information has been input into GUI 344, the user can click the Submit Appointment Request” button 375 of GUI 344 to send the entered information for processing and to make an appointment at block 206.

Referring again to FIG. 2, an appointment request confirmation notice is generated by IHSN 20 and transmitted to personal onsite at the prison at block 208. In some embodiments, the appointment request confirmation notice takes the form of an email. However, one of ordinary skill in the art will understand that the appointment request confirmation can take other forms, including a telephone call, a text message, a fax, or any other electronic communication.

At block 210, in some embodiments, one or more documents are uploaded to IHSN 20. For example, FIG. 3F illustrates one example of a GUI 376 displayed to a user of IHSN 20 once an appointment request has been submitted. As shown in FIG. 3F, GUI 376 includes an “Upload Files” button 377 and a “Create New Appointment Request” button 378. Selecting button 378 will take the user back to GUI 330 shown in FIG. 3C, and selecting button 377 takes the user to GUI 379 shown in FIG. 3G. As shown in FIG. 3G, GUI 379 includes a “Browse” button 380 that when selected enables the user to identify one or more documents to upload to IHSN 20.

The documents that are uploaded can include supporting documentation concerning the patient's scheduled visit. In some embodiments, a user is able to upload one or more images, pdf files, MS office files, or other file type such that these files are attached to the corresponding appointment request. IHSN 20 also can be configured to notify the user they have the option to fax their supporting documentation to IHS (e.g., company providing IHSN 20), and provide the request ID and fax number. In some embodiments, IHSN 20 is configured to display the following language to a call center operator through GUI 30: “Supporting documentation upload—please upload the Consultation Form and any other supporting materials (medical history, lab results, client approval letters, etc.) that we may need to make this appointment. You can also fax these materials to IHS at (###) ###-####. When faxing be sure to include the Request ID on every page of your fax.”

In some embodiments, IHSN 20 is configured to show current appointments already scheduled (plus inmate security level, Strategic Threat Group, special security instructions, gender, etc.) for the facility requesting this appointment. This enables the call center operator to try to schedule the new appointment at the same date/time to reduce transportation costs. IHSN 20 is configured to facilitate operator scheduling to batch appointments when possible within the constraints of inmate security requirements (as documented in the facility specific rules provided by the client). If a call center operator was unable to use the optimal provider, the operator can log the reason using a pick list of options provided by IHSN 20 through portal 30. If an appointment location is different from a selected provider's office address, IHSN 20 is configured to allow an operator to enter an appointment location address separately. In some embodiments, follow up visits will be handled the same as initial visits

Periodic Notifications

In some embodiments, IHSN 20 is configured to send periodic (e.g., hourly, once a day, twice a day, etc.) confirmation emails to a prison indicating that appointment(s) have been scheduled. IHSN 20 is configured to log when the prison confirms, and will follow up if the prison doesn't respond (timing for follow up to be client specific). If notification is required by a third party administrator (“TPA”) for requested medical service, call center personnel will contact a TPA by email (for audit purposes) after making the appointment to notify them of the pending treatment.

IHSN 20 is configured, in some embodiments, to send out a reminder email (e.g., daily or as needed or otherwise configured) to each prison notifying them that they have appointments within the next few days. In some embodiments, IHSN 20 is configured to send out an email to each facility that had an appointment cancelled to notify them that they should log into the system to confirm it's appropriate. IHSN 20 can be configured to send out an email to each facility that had an ER visit was logged to notify them that they should log into the system to confirm it's appropriate. IHSN 20 also can be configured to enable facility user to notate whether ER visit turned into an inpatient event. If so, for example, IHSN 20 is configured to take the user immediately to the appointment request screen so they can enter the inpatient event as a Billing/Tracking only request. Further, IHSN 20 is configured to enable facility user to notate, as described in greater detail below, that they aren't sure yet whether the ER visit turned into an inpatient event. In some embodiments, IHSN 20 is configured to send an email to facility 24 hours later reminding them to enter an inpatient request if the inmate was held overnight.

Appointment Lookup

Users can log into IHSN 20 via portal 28 using a computer 54 or mobile device 100 to view the next day's (or user specified date range) appointments for all prisoners. Appointments can be viewed in web portal 28, printed, and/or downloaded into an Excel (or other formats) file. In some embodiments, IHSN 20 is configured to enable onsite medical professionals and staff to log into IHSN 20 via portal 28 to log whether an appointment has occurred or not. One example of when this may occur is on or after the planned schedule date / time (and therefore would not apply if an appointment was cancelled in advance). The notification would be notify IHS that an inmate did or didn't in fact go to their appointment.

IHSN 20 can be configured to provide onsite medical professionals with a mechanism to log ER visits online directly into the system. This advantageously eliminates the need to contact a call center operator for such visits. In some embodiments, IHSN 20 sends an email confirmation (e.g., hourly, daily, twice a day, etc.) to each prison to notify them that an ER visit occurred and they can view the details by logging into the system. IHSN 20 can be configured to provide a real-time report showing the urgent care visits for all inmates from that facility for the day.

IHSN 20 is configured to provide, in some embodiments, a dashboard for onsite medical directors to view and manage their facility's appointment calendar (view existing appointments, request new appointments, change or cancel appointments, review reports, etc.) via portal 28. For example, a user can log into IHSN 20 via portal 300 shown in FIG. 3A and search for an existing appointment by clicking on Search button 324 of GUI 320 shown in FIG. 3B.

FIG. 3H illustrates one example of a GUI 381 configured to provide a user with the ability to search for an existing appointment. As shown in FIG. 3H, GUI 381 includes a first field 382 of predefined options that can be selected as to the Status of an appointment, e.g., canceled, complete, pending, in process, etc., and a second field 383 of predefined options that can be selected as to the Facility of an appointment.

GUI 381 also includes a number of text entry fields each being configured to allow a user to entry free-form text and a number of pull-down menus each configured to enable a user to select predetermined information. Examples of text entry fields include, but are not limited to, a First Name field 384, a Last Name field 385, a Client Inmate ID field 386, and an Appointment (“Appt”) Required ID (“ReqID”) field 387. Examples of pull-down menus include, but are not limited to, a Source menu 388, a Sort By menu 389, an In/Outpatient menu 390, and a Specialty menu 391.

GUI 381 also provides a user with the ability to search within predefined ranges. For example, GUI 381 includes a calendar popup menus 392, 393 enabling a user to search based on a range of dates during which the appointment is scheduled. Another pair of calendar popup menus 394, 395 are provided to enable a user to search based on when a request for an appointment was made. A Reset button 397 is provided to clear any data or selection made on GUI 381, and a Search button 398 is provided to enable the user to request IHSN 20 to use the entered data to identify any matching appointments. For example, when Search button 398 is clicked, the entered or selected data is used by processor 24 (FIG. 1A) to search data storage unit(s) 26 for matching appointments.

FIG. 31 illustrates one example of a GUI 400 displaying the results of an appointment search in accordance with some embodiments. GUI 400 includes a number of buttons 401 that are disposed in a column adjacent to the column in which each appointment request ID (Req Id) is provided for each appointment request that matches the search criteria is located. GUI 400 also includes a “View/Upload Files” button 402, a “View Appt” button 403, a “Confirm” button 404, a “Cancel Appt” button 405, a “Complete” button 406, and a “Print Form” button.

Selecting one of the buttons 401 along the left-most column to select the appropriate inmate, and clicking on the View/Upload Files button 402 will result in IHSN 20 to display GUI 376 shown in FIG. 3F such that a user can upload any additional documentation to IHSN 20. If the View Appt button 403 is clicked instead of the View/Upload Files button 402, then a GUI is displayed to the user with the information concerning the requested appointment. One example of such a GUI is GUI 408 illustrated in FIG. 3J. As shown in FIG. 3J, GUI 408 displays pertinent information concerning the requested appointment including, but not limited to, whether the appointment has been confirmed, the date of the appointment, the specialist, location, date, time, and patient information.

Appointment Rescheduling and Cancellation

If a client provides IHS with a daily eligibility file, IHSN 20 is configured to check eligibility file for inmate's having appointments that have moved from one facility to another. These appointments need to be re-confirmed by sending a notification email to the onsite medical director at the new facility to confirm the appointment at that provider still works. If appropriate the onsite medical director at the new facility will cancel or change the appointment.

Referring again to FIG. 31, GUI 400 also provides the user with the ability to confirm or cancel a particular appointment by selecting the appropriate patient using the applicable button 401 and clicking the Confirm button 404 or clicking the Cancel button 405. GUI 400 also enables a user to print the selected information by clicking the Print Form button 407, or to complete the use of GUI 400 by clicking the Complete button 406.

In some embodiments, if the Cancel button 405 is clicked then another GUI is displayed to the user. One example of such a GUI is GUI 409 illustrated in FIG. 3K. Cancel Appointment GUI 490 includes a number of fields that are populated with the information stored in one or more data storage units 26 concerning the appointment. Examples of the populated information includes, but are not limited to, status, inmate name, facility name and ID number, submitter name, referring medical professional, requested medical procedure, appointment date and time, and provider name and phone number. GUI 409 also includes a number of selectable buttons 410, 411, 412, 413, 414, 415, and 416 associated with a predefined cancellation reason. For example, button 410 is associated with the reason “Facility—Cancel and Reschedule,” button 411 is associated with the reason “Provider Cancelled—Need to Reschedule,” button 412 is associated with “Security Cancelled,” button 413 is associated with “Medical need for treatment no longer exists,” button 414 is associated with “Inmate Refused Treatment,” button 415 is associated with “Inmate Transferred,” and button 417 is associated with “Inmate Released.” One of ordinary skill in the art will understand that fewer, more, or different reasons can be provided.

GUI 409 also includes a button 417, which is associated with the reason “Other.” A text entry box 418 is provided for additional notes such that a user can enter a particular reason for the cancellation. GUI 409 also includes a “Cancel Appointment” button 419 and a “Cancel & Reschedule” button 420. In some embodiments, clicking button 419 will cancel the appointment and then return the user to a home screen, and clocking button 420 will cancel the appointment and then take the user back to GUI 344 shown in FIG. 3E.

When the an appointment is canceled and/or rescheduled, IHSN 20 notifies the provider. If a provider cancels an appointment, prison medical professional(s) are notified and appointments are reschedule as appropriate. Call center personnel may advise providers that if a provider needs to cancel an appointment at the last minute (evening before or morning of appointment), provider should contact the facility at a central control office to cancel the appointment (no last minute time changes can be made off hours). In some embodiments, users or call center personnel log the cancellation reason code, specifying the cancellation reason and user ID that cancelled the appointment into IHSN 20. If requesting a reschedule system to pre-populate the request info from the initial request so the user doesn't need to re-type the request details. In some embodiments, IHSN 20 is configured to provide a real time report showing appointments with a date in the past that have not been marked as completed.

Urgent Care (Emergency) Logging

IHSN 20 also includes, in some embodiments, the ability to log an ER visit. For example, if a user clicks the Continue to ER button 341 in GUI 300 shown in FIG. 3C, a “Facility ER Visit” GUI is displayed to the user. One example of such an ER visit GUI is GUI 421 shown in FIG. 3L. As shown in FIG. 3L, GUI 421 displays information entered using GUI 300, i.e., the facility, inmate name, source, and gender, and also includes calendar pop-up menus 422, 423 for the admit date and the discharge date.

GUI 421 also includes buttons 424, 425, and 426 for identifying the ER event resolution. For example, button 424 is to be selected when an inmate was admitted to an ER, button 425 is to be selected when an inmate was not admitted to an ER, and button 426 is to be selected when it has not been determined whether the patient has been admitted or not. If button 426 is selected, a text entry field 427 is provided such that a user can provide details as to why it has not yet been determined if the inmate has been admitted to an ER. Another text entry box 428 is provided so that a user can identify the medical professional making the referred, and a pull-down menu 429 also is provided such that the user can select the hospital name of the ER.

With the information entered into GUI 421, the user has the option of submitting the ER visit information by clicking the “Submit ER Visit” button 430 or to submit the ER visit information and create an inpatient appointment request by clicking the “Submit ER Visit/Create Inpatient Appt Request” button 431. If button 431 is selected, then, in some embodiments, the user is taken to GUI 344 illustrated in FIG. 3E.

Offsite Visit Form

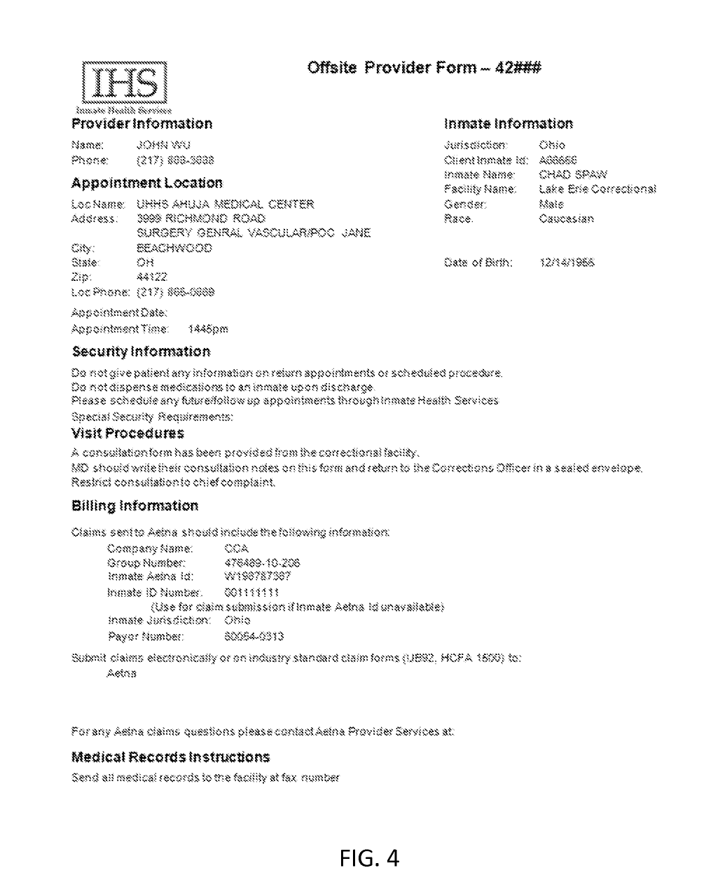

Once the client user logs into IHSN 20, s/he is provided the ability, in some embodiments, to print (an) Offsite Visit Form(s) showing the appropriate inmate and appointment data elements, billing instructions for the provider, security instructions for the provider and other client specific information. In some embodiments, an Offsite Visit Form can be printed for any appointment that has been scheduled or completed. On an as needed basis, an Offsite Visit Form is sent directly to the provider. One example of an offsite provider form is illustrated in FIG. 4.

In some embodiments, IHSN 20 is configured to provide a function for onsite clerks to upload the Offsite Visit Form or other scanned/image files (pdf, jpg, etc.) to IHSN 20 such that the uploaded Form is tied to a specific appointment request. In some embodiments, this function is configured to work at any time during the process (i.e. while entering the request, after the appointment has occurred, etc.) as described above.

Real-Time Monitoring of Appointment Status

IHSN 20 is configured to provide certain users with real-time monitoring. For example, IHSN 20 is able to provide users with the ability see what step the appointment request is currently on and view notes (including date/time stamps, names of people involved, etc.) for all steps completed. For example, IHSN 20 can provide a user with a status of one of or more of the following steps in an appointment request process:

Request submitted, no action taken yet;

Request received email confirmation sent to onsite medical staff;

Call center operators in process of calling providers;

Call center operators unable to locate provider, a TPA team notified that additional provider(s) needed;

Appointment scheduled;

Onsite medical director notified via email;

Onsite medical director acknowledged receipt of appointment details;

Appointment cancelled;

CALL CENTER cancellation notification made to provider; OR

CALL CENTER cancellation notification made to onsite medical staff;

CALL CENTER next day notification of appointment sent; and

Appointment marked complete by facility.

CLAIMS, ANALYSIS, REPORTING, CENSUS PROCESSING

In some embodiments, census feed(s) from client(s) is received and/or uploaded to IHSN 20 via back-end portal 32 and then distributed to one or more TPAs and call center personnel via IHSN 20.

In some embodiments, a client will provide a daily load of all current inmates' eligibility info. For example, this can be sent from client to IHSN 20 via back end portal 32, including jurisdiction and jurisdiction's ID number. IHSN 20 is configured to pass the information to a TPA for assignment of corresponding insurance ID number.

If eligibility data not available from client and/or call center personnel receives an appointment request for an inmate not in IHSN 20, call center personnel will create a new database entry for that inmate via portal 30. In some embodiments, a list of “new” inmates is transmitted to and uploaded via back-end portal 32 periodically (e.g., daily) so that IHSN 20 can assign an IHS ID number and pass to a TPA for assignment of an insurance ID number (per process above). If daily update file of additions/updates/deletions of inmates from a census file is sent from a client to IHSN 20, an updated list can be provided by IHSN 20 to call center personnel and a TPA.

In some embodiments, IHSN 20 is configured with a matching routine that ties inmate jurisdiction ID number with a TPA insurance ID number for each prisoner and create a cross reference table to be used by all parties. New prisoners are assigned an insurance ID number by a TPA, and this will be provided in the weekly file back from a TPA.

In some embodiments IHSN 20 is configured to provide a file periodically (e.g., daily, weekly, monthly, etc.) to call center personnel with the updates to the inmate census, including insurance ID numbers once they've been assigned. IHSN 20 is configured to store inmate eligibility data with start and end dates in one or more databases residing in a storage medium 26.

In some embodiments, IHSN 20 is configured with a claims tracking system (claims data warehouse). For example, IHSN 20 is configured to receive and store claims data files from a TPA, including prison number, inmate IHS ID number, jurisdiction ID number and a TPA insurance ID number. IHSN 20 is configured to store data for all provider ICD9 payment codes, costs, diagnoses for office visits, tests, procedures, etc. for analysis/reporting. IHSN 20 can be configured to store appointments data input from call center personnel via portal 30. Claims for offsite scheduled appointments, hospital stays, tests and urgent care visits can be sent by a TPA and stored into the database residing in the one or more storage mediums 26 for future analysis and reporting.

IHSN 20 is configured to generate and provide one or more reports to a user. Examples of reports that can be generated by a IHSN 20 include, but are not limited to,

Active. In some embodiments, the active report provides identifies all active appointment requests as well as the appointment status, pend reason, and whether the appointment is past due. One of ordinary skill in the art will understand that other details concerning an appointment request can be included in the active report.

Appointment Listing. The appointment listing report identifies each appointment broken down by a selected metric, such as by facility. The appointment listing report also can include the full details of each appointment broken out by facility and date range.

Daily Tally. The daily tally report provides a summary of inbound, processed, completed, and remaining appointment requests.

ER Visit Tracking The ER visit tracking report provides a comprehensive overview of data for each ER visit. In some embodiments, the data is provided on a per facility and for a particular date range.

Past Due Confirmations. The past due confirmations report shows scheduled appointments for which facility confirmation is overdue.

Scheduled/Cancelled. The scheduled/canceled report provides the date an appointment was requested, the date on which an appointment was scheduled, and a date on which an appointment was cancelled, if applicable. In some embodiments, the report also includes a count for the number of days required to resolve for each request in a date range.

Appointment Accessibility. The appointment accessibility report provides a count of appointment requests and successfully booked appointments, grouped by prison, DRG/CTP code, and ‘in network’/‘out of network’.

Overall Cost (Summary). The overall cost summary report provides the total claims costs for a selected time interval, e.g., the previous 12 months, for a selected prison or other sortable metric.

Overall Cost (Detailed). The overall cost detailed report provides the cost of each claim broken out by inmate, grouped by prison and onsite prison medical professional authorizing treatment at the prison.

Monthly Visit Totals Summary. The monthly visits total summary report includes the total number of visits for a period of time (e.g., day, week, month, year, etc.) grouped by prison and onsite prison medical professional authorizing treatment at the prison.

Appointment Center Utilization Review. The appointment center utilization review, which also can be referred to as an average visits per ticket report, provides the average number of appointments per inmate per month, and average cost per inmate, for last a period of time (e.g., day, week, month, year, etc.). In some embodiments, the appointment center utilization review report is grouped by prison, but one of ordinary skill in the art will understand that the data can be grouped using other data.

Treatment Over Utilization. A treatment over utilization report provides an initial onsite medical professional's complaint versus claims for that inmate over a X period of time.

Onsite Potential. In some embodiments, an onsite potential report is generated by performing analytics on the data stored in one or more storage devices 26. For example, processor 24 analyzes stored data looking for patterns of multiple visits for one specialty at one facility that might benefit from an onsite visit. The trends are displayed to a user as will be understood by one of ordinary skill in the art.

Other Analysis. Processor(s) 24 also are configured to perform analysis on claims to identify patterns of over-utilization, unnecessary treatments, and fraud to list only a few examples. Further, processor fraud, etc. In some embodiments, processor(s) 24 are configured to provide an analysis of inmate claims to identify possibly pre-existing conditions that would be covered by prior insurance/government program.

In some embodiments, IHSN 20 is configured to receive and process a weekly claim detail report from a TPA. The weekly report identifies the claims paid during the previous week. IHSN 20 can merge the information included in the weekly claim detail report with information stored in one or more data storage mediums 26 that may not be included in the report (e.g., facility, jurisdiction, etc.). The merge report can be made available to users of IHSN 20, as described in greater detail below, and/or emailed to a predetermined list of people.

In some embodiments, the following reports are generated by IHSN 20 on a monthly basis:

Scheduling Breakdown. The scheduling breakdown report provides a breakdown of appointment requests received for a relevant period of time (e.g., by week, month, etc.) based on data acquired during the previous month or relevant time period. This report can be provided by the appointment request status (scheduled, pended, cancelled, etc.).

Cancellation Detail. The cancellation detail report provides details, including reasons and notes, of all requests cancelled during the previous month. One of ordinary skill in the art will understand that the cancellation detail report can be generated for other periods of times, e.g., weeks, quarters, years, etc.

Cancellation Summary. The cancellation summary report provides an overview of the cancellations based on the cancellation reason. For example, the cancellation reason can be one of the reasons identified on GUI 409 shown in FIG. 3L.

Initial Turnaround Metrics. The initial turnaround metrics report demonstrates the amount of time between a client request received by IHS, e.g., a company providing IHSN 20, and an initial activity taken on each request.

Appointment Resolution Turnaround Time. In some embodiments, the appointment resolution turnaround time report provides a summary of the time elapsed between a client request and a company's resolution of each request.

Scheduled By Requested Date. The scheduled by requested date report provides a summary of whether requests were scheduled by the requested appointment target date.

Inpatient/Outpatient Breakdown. The inpatient/outpatient breakdown report provides a count for the number of inpatient appointments and the number of outpatient appointments made during a period of time (e.g., day, month, quarter, year, etc.).

Pend Reason Breakdown. The pend reason breakdown report provides counts of requests pended during the month, or other time interval, by pend reason.

In some embodiments, IHSN 20 also is configured to provide the following annual reports cost of closest provider option, cost of lowest medical cost provider option; cost of highest medical cost provider option; and/or cost of average overall cost provider option.

In some embodiments, the reports are accessed by clicking the View button 328 of GUI 320 shown in FIG. 3B. Clicking button 328 results in another GUI, such as GUI 432 shown in FIG. 3M. GUI 421 includes a pair of hyperlinks 432, 433 with each hyperlink linking to an available report for the registered user. As will be understood, depending on the profile information of the user, he or she will be provided access to different types of reports.

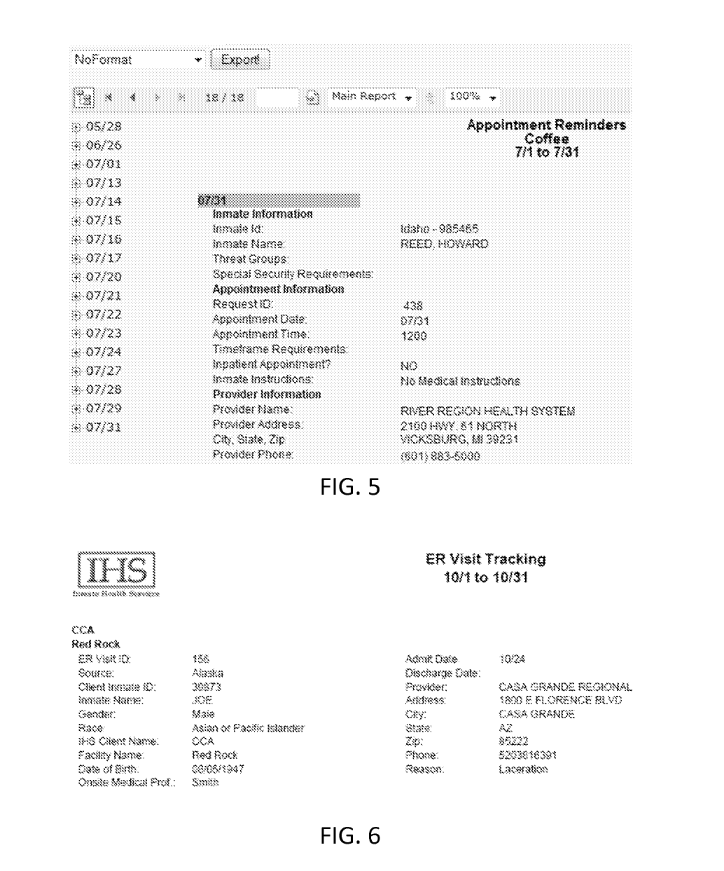

When a user clicks on one of the hyperlinks, such as the “Appointment Reminder” hyperlink 432 or the “ER Visit Tracking” hyperlink 433, the user is presented with another GUI. For example, FIG. 3N illustrates a GUI 434 the provides a user with the ability to run a report. GUI 434 includes a pair of calendar pop-up buttons 435, 436 for enabling a user to select a start date and an end date for the report. GUI 434 also includes menus 437, 438, and 439 enabling a user to select a client, a facility, and a source for the report. A “Display Report” button 440 is provided and causes a report to be generated based on the information input into GUI 434. FIG. 5 illustrates one example of an appointment reminder report in accordance with some embodiments, and FIG. 6 illustrates one example of a ER visit tracking report in accordance with some embodiments.

IHSN 20 also is configured to perform analyses, performed by processor(s) 24, to identify an amount of savings that are lost due to the lack of adherence to the protocol identified by the SCAN algorithm, which as described above is configured to identify a healthcare provider for a particular inmate that will treat whatever ails the inmate in a cost-effective and/or timely manner based on the data stored in the database maintained by IHSN 20. Further, IHSN 20 is able to identify corrective action to take and to alert users if the violation is in the future, e.g., a reservation is made for an inmate at a location not recommended by the SCAN algorithm, or is ongoing, e.g., an inmate is being treated currently at a location not recommended by the SCAN algorithm.

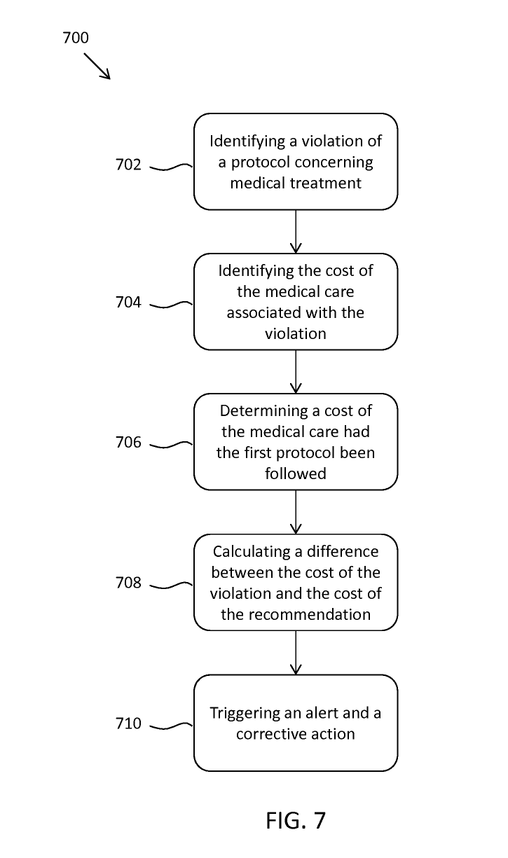

FIG. 7 is a flow diagram of one example of a method of identifying a violation and generating an alert with a corrective action in accordance with some embodiments. At block 702, processor(s) 24 analyzes the database stored in one or more data storage units 26 to identify at least one instance of when a protocol, such as a recommendation of the SCAN algorithm, has not been followed. One example of an instance when a recommendation of when the SCAN algorithm is not followed (referred to herein as a “SCAN violation”) is when an inmate is admitted initially to an ER and then moved to inpatient care at the same hospital. In such a circumstance, the ER hospital may not be the recommended treatment facility for the particular ailment, but the patient may be brought to the hospital because of the ER facility. Examples of other circumstances include a client (e.g., a prison or correctional facility) ignoring the SCAN recommendation or by simply scheduling without receiving a SCAN recommendation.

At block 704, IHSN 20 identifies the cost for the medical care associated with the SCAN violation. For example, if the violation concerns a reservation that has yet to be fulfilled, i.e., a future reservation, then an estimated cost for the medical treatment at the medical facility that is not recommended is calculated. If the violation concerns the ongoing treatment at a medical facility that is not recommended by the SCAN algorithm, then the actual cost of the medical care is stored in the database as it will be received by IHSN 20 either having been manually entered during an ER visit logging or the information was included in a report or file received by IHSN 20 from the hospital, the prison or correctional facility where the inmate is located, and/or from a TPA to identify a few possibilities.

At block 706, IHSN 20 determines and/or estimates the cost for the medical care the inmate is receiving at the medical facility recommended by SCAN. The calculated or determined medical cost for the SCAN recommended facility can be based on one or more data points acquired by IHSN 20. Such data points can be acquired by IHSN 20 over a period of time, e.g., by other inmates having undergone similar and/or identical procedures at the hospital, or can be provided from the medical facility in a price list or other report. Regardless of the manner in which the data points are acquired, IHSN 20 stores the information in one or more data storage units 26.

At block 708, IHSN 20 calculates a difference in cost (i.e., a “delta cost”) between the cost identified at block 704 and the cost determined at block 706. Put another way, at block 708, IHSN 20 calculates the delta cost between the cost associated with the violation, i.e., an estimated cost if the medical treatment is provided at the facility not recommended by SCAN or if ongoing treatment continues at the facility not recommended by SCAN, and an estimated cost for obtaining treatment for the patient at the medical facility recommended by SCAN. The delta cost can be stored in the one or more data storage units 26 as will be understood by one of ordinary skill in the art.

At block 710, an alert and/or report is generated and transmitted if there is a difference in cost. In some embodiments, the alert is triggered immediately if the delta cost is above a predetermined threshold value. The alert can be triggered in real-time and/or in a daily or weekly report generated by IHSN 20. In instances where the violation concerns ongoing treatment, the alert can be triggered immediately. If, for example, the violation concerns a future appointment, the alert can be made at a predetermined reporting interval and/or in real-time. IHSN 20 also can be configured to provide call center personnel, client personnel (e.g., prison or correctional facility personnel), and/or TPA personnel with real-time access to the underlying data by logging into IHSN 20.

The alert can be transmitted to an insurance provider, prison personnel, and/or to a call center personnel. Further, the alert can be transmitted in a number of ways and can include a variety of data points. For example, in some embodiments, the alert is an email that includes a message requesting the recipient of the alert to log into IHSN 20 to view a detailed report. In some embodiments, the report is transmitted as an attachment to the email. The report can identify the inmate, or inmate ID, the healthcare provider and current treatment being administered to the inmate, the preferred healthcare provider for the procedure, the accrued costs to treat the inmate to date, and the cost savings if the SCAN-recommended provider is used. Thus, the alert can identify a corrective action to take, such as changing an appointment for a future medical treatment to a SCAN-recommended facility or to move a patient from one medical facility (i.e., the medical facility that is not recommended by SCAN) to another medical facility (i.e., the SCAN-recommended facility).

In some embodiments, the alert is generated in the form of an “exception report” that is transmitted to a client (e.g., insurance company, prison or correctional facility) on a daily or weekly basis. One of ordinary skill in the art will understand that other time periods can be used.

The disclosed systems and methods advantageously enable the marshalling of inmate healthcare data from a plurality of sources (e.g., correctional facilities, healthcare providers, and TPAs) into a form that enables inmate healthcare costs to be tracked and more efficient methods of providing medical care to inmates to be suggested and recommended. As described above, the disclosed systems and methods provide users of the system with the ability to schedule appointments for inmates at a number of different medical facilities. Advantageously, the disclosed systems and methods provide users with suggestions for the location at which a particular medical procedure should be performed for a particular patient such that the procedure is performed in a cost-effective manner and/or in a timely manner. The recommendations are made in view of medical cost related factors, quality related factors, distance related factors, risk mitigation related factors, and time constraint factors.

The advantages afforded by the disclosed systems and methods also include the ability to improve clinical outcomes by avoiding adverse events, reduced cost of care by limiting the reliance on highly restricted networks of hospitals and specialty physicians, and improved access to data and reports to provide more effective analysis of services, utilization, and quality of financial metrics and customized reporting. Additionally, the disclosed systems and methods provide improved transparency of costs and expenses in a more timely fashion, and provide a real-time notification system of protocol violations such that inmates can be transferred from a more expensive medical provider to a less expensive medical provider.

In some embodiments, a system includes a non-transitory machine readable storage medium and a processor in communication with the non-transitory machine readable storage medium. The processor is configured to analyze a database of patient healthcare data to identify a violation of a protocol for providing a patient with one or more medical procedures, determine an estimated cost for providing the patient with the one of more medical procedures if the protocol were to be followed, calculate a difference between a cost for providing the one or more medical procedures in violation of the protocol and the estimated cost for providing the inmate with the one or more medical procedures in accordance with the protocol, and generate an electronic notice identifying the violation of the protocol and at least one of a corrective action to be taken and a savings value if the corrective action is taken.

In some embodiments, the processor is configured to cause the electronic notice to be transmitted to at least one user of the system.

In some embodiments, the processor is configured to cause the electronic notice to be displayed to at least one user of the system.

In some embodiments, the corrective action includes at least one of changing a location associated with an appointment for providing medical treatment and moving the patient from a first healthcare facility to a second healthcare facility.

In some embodiments, the database includes healthcare data received from a plurality of different sources.

In some embodiments, the plurality of different sources includes a correctional facility and a third-party administrator.

In some embodiments, the processor is configured to generate the electronic notice if the difference between the incurred cost and the estimated cost is greater than a predetermined threshold.

In some embodiments, a method includes analyzing a database of healthcare data to identify a violation of a protocol for providing a patient with one or more medical procedures, determining an estimated cost for providing the patient with the one of more medical procedures if the healthcare protocol were to be followed, and calculating a difference between a cost for providing the one or more medical procedures in violation of the protocol and the estimated cost for providing the inmate with the one or more medical procedures in accordance with the protocol. An electronic notice identifying the violation of the protocol and at least one of a corrective action to be taken and a savings value if the corrective action is taken is generated.

In some embodiments, a method includes at least one of transmitting the electronic notice to at least one user of a system and displaying the electronic notice to at least one user of the system.

In some embodiments, the corrective action includes at least one of changing a location associated with an appointment for providing medical treatment and moving the patient from a first healthcare facility to a second healthcare facility.

In some embodiments, a method includes populating the database with healthcare data from a plurality of different sources.

In some embodiments, the plurality of different sources includes a correctional facility and a third-party administrator.

In some embodiments, a method includes comparing the difference between the incurred cost and the estimated cost to a predetermined threshold.

In some embodiments, at least a portion of the disclosed methods can be embodied in the form of methods and apparatus for practicing those methods. Further, the disclosed systems and methods also can be embodied in the form of program code embodied in tangible media, such as floppy diskettes, CD-ROMs, DVD-ROMs, Blu-ray disks, hard drives, or any other machine-readable storage medium, wherein, when the program code is loaded into and executed by a machine, such as a computer, the machine becomes an apparatus for practicing the invention. The disclosed systems and methods also can be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although the disclosed systems and methods have been described in terms of exemplary embodiments, they are not limited thereto. Rather, the appended claims should be construed broadly, to include other variants and embodiments of the systems and methods, which may be made by those skilled in the art without departing from the scope and range of equivalents of the systems and methods.

What is claimed is:

1. A system, comprising:
a non-transitory machine readable storage medium; and
a processor in communication with the non-transitory machine readable storage medium, the processor configured to:
analyze a database of patient healthcare data to identify a violation of a protocol for providing a patient with one or more medical procedures;
determine an estimated cost for providing the patient with the one of more medical procedures if the protocol were to be followed;
calculate a difference between a cost for providing the one or more medical procedures in violation of the protocol and the estimated cost for providing the inmate with the one or more medical procedures in accordance with the protocol; and
generate an electronic notice identifying the violation of the protocol and at least one of a corrective action to be taken and a savings value if the corrective action is taken.

2. The system of claim 1, wherein the processor is configured to cause the electronic notice to be transmitted to at least one user of the system.

3. The system of claim 1, wherein the processor is configured to cause the electronic notice to be displayed to at least one user of the system.

4. The system of claim 1, wherein the corrective action includes at least one of changing a location associated with an appointment for a medical procedure and moving the patient from a first healthcare facility to a second healthcare facility.

5. The system of claim 1, wherein the database includes healthcare data received from a plurality of different sources.

6. The system of claim 5, wherein the plurality of different sources includes a correctional facility and a third-party administrator.

7. The system of claim 1, wherein the processor is configured to generate the electronic notice if the difference between the incurred cost and the estimated cost is greater than a predetermined threshold.

8. A method, comprising:
analyzing a database of healthcare data to identify a violation of a protocol for providing a patient with one or more medical procedures;
determining an estimated cost for providing the patient with the one of more medical procedures if the protocol were to be followed;
calculating a difference between a cost for providing the one or more medical procedures in violation of the protocol and the estimated cost for providing the inmate with the one or more medical procedures in accordance with the protocol; and
generating an electronic notice identifying the violation of the protocol and at least one of a corrective action to be taken and a savings value if the corrective action is taken.

9. The method of claim 8, further comprising at least one of transmitting the electronic notice to at least one user of a system and displaying the electronic notice to at least one user of the system.

10. The method of claim 8, wherein the corrective action includes at least one of changing a location associated with an appointment for a medical procedure and moving the patient from a first healthcare facility to a second healthcare facility.

11. The method of claim 8, further comprising populating the database with healthcare data from a plurality of different sources.

12. The method of claim 11, wherein the plurality of different sources includes a correctional facility and a third-party administrator.

13. The method of claim 8, further comprising comparing the difference between the incurred cost and the estimated cost to a predetermined threshold.

14. A non-transitory machine readable storage medium encoded with program code, wherein when the program code is executed by a processor, the processor performs a method, the method comprising
analyzing a database of healthcare data to identify a violation of a protocol for providing a patient with one or more medical procedures;
determining an estimated cost for providing the patient with the one of more medical procedures if the protocol were to be followed;
calculating a difference between a cost for providing the one or more medical procedures in violation of the protocol violation and the estimated cost for providing the inmate with the one or more medical procedures; and
generating an electronic notice identifying the protocol violation and at least one of a corrective action to be taken and a savings value if the corrective action is taken.

15. The non-transitory machine readable storage medium of claim 14, wherein the method includes causing the electronic notice to be transmitted to at least one user of a system.

16. The non-transitory machine readable storage medium of claim 14, wherein the method includes causing the electronic notice to be displayed to at least one user of a system.

17. The non-transitory machine readable storage medium of claim 14, wherein the corrective action includes at least one of changing a location associated with an appointment for a medical procedure and moving the patient from a first healthcare facility to a second healthcare facility.

18. The non-transitory machine readable storage medium of claim 14, wherein the database includes healthcare data received from a plurality of different sources.

19. The non-transitory machine readable storage medium of claim 18, wherein the plurality of different sources includes a correctional facility and a third-party administrator.

20. The non-transitory machine readable storage medium of claim 14, wherein the electronic notice is generated if the difference between the incurred cost and the estimated cost is greater than a predetermined threshold.
